(19) United States
(12) Patent Application Publication
(10) Pub. No.: US 2008/0197162 A1
(43) Pub. Date: Aug. 21, 2008

(54) ARTICLE CARRIER WITH STOWABLE CROSS RAIL

(76) Inventors: John E. Klinkman, Riley Township, MI (US); John H. Harberts, Macomb, MI (US); Gary Fulkerson, White Lake, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/034,506

(22) Filed: Feb. 20, 2008

Related U.S. Application Data
(63) Continuation-in-part of application No. 11/944,005, filed on Nov. 21, 2007.
(60) Provisional application No. 60/860,739, filed on Nov. 22, 2006.
(60) Provisional application No. 60/890,784, filed on Feb. 20, 2007.

(51) Int. Cl. B60R 9/045

(52) U.S. Cl. 224/314; 224/321; 224/315

(57) ABSTRACT

An article carrier assembly for a vehicle is provided, including a side rail and a cross rail. The side rail includes a top surface that defines, at least in part, a maximum height of the side rail. The cross rail is operable to be secured to the side rail in a stowed position and a deployed position. The cross rail is located generally below the maximum height of the side rail when the cross rail is in the stowed position, and the cross rail is above the maximum height of the side rail when the cross rail is in the deployed position.

### CROSS REFERENCE TO RELATED APPLICATIONS

This application is a continuation-in-part of U.S. patent application Ser. No. 11/944,005, which claims priority to U.S. Provisional Patent Application 60/860,739, filed Nov. 22, 2006. This application also claims priority to U.S. Provisional Patent Application 60/890,784, filed Feb. 20, 2007. Each of these related applications are incorporated by reference in their entirety.

### TECHNICAL FIELD

The present disclosure relates generally to an article carrier assembly and, more particularly, to an article carrier assembly including at least one cross rail that is secured to a side rail and selectively moveable between a stowed position and a deployed position.

### BACKGROUND

Article carrier assemblies are well known for use in storing or retaining luggage, bicycles, small boats, or the like on the exterior of a motor vehicle. Typically, two side rails that are provided generally parallel to one another and extend between the front and the rear of the vehicle. At least one cross rail is positioned between and selectively secured to the two side rails by way of a support.

In one type of article carrier assembly, each cross rail is positioned generally perpendicular to the side rails. Cross rails are typically used to secure accessories and cargo to the article carrier assembly. However, when the article carrier assembly is not in use, the cross rails provide several disadvantages. First, because the cross rails are typically positioned generally perpendicular in relation to the front and rear of the vehicle, the cross rails increase wind noise and decreases the fuel economy of the vehicle.

Moreover, some article carrier assemblies position the cross rails on top of the side rails. Because the cross rails are positioned on top of the vehicles, the cross rails also add extra height as well. Increased vehicle height is undesirable, especially when the vehicle is being shipped inside of a cargo carrier. Cargo carriers are typically used to ship multiple vehicles from the assembly plant to a dealer. Space inside the cargo carrier is very limited, and the extra height of the cross rails results in fewer vehicles being placed inside the carrier. In one approach, the article carrier assemblies are removed from the top of the vehicle before shipment, and then placed back on the vehicle after shipment. However, this approach results in extra labor and costs to ship the vehicle.

Thus, there exists a need for an article carrier assembly where the cross rail can be stowed when not in use in a position that does not increase the overall height of the vehicle.

### BRIEF DESCRIPTION OF THE DRAWINGS

FIG. 1 is an elevational perspective view of the top of a motor vehicle with an article carrier assembly in a deployed position, and includes a pair of side rails and a pair of cross rails;

FIG. 2 is an enlarged view of Region 2 in FIG. 1;

FIG. 3 is a partially cross sectional view of one of the side rails and one of the cross rails in a stowed position;

FIG. 4 is a partially exploded view of the cross rail, the side rail, a closure device and an adjustable mount when the article carrier assembly is in the deployed position;

FIG. 5 is an elevational perspective view of one of the cross rails;

FIG. 6 is an alternative exemplary illustration of the article carrier assembly, including one of the side rails;

FIG. 7 is a process flow diagram of a method of deploying and stowing a cross rail of an article carrier assembly;

FIG. 8 is an elevational perspective view of an article carrier assembly in a stowed position, and includes a pair of side rails and a pair of cross rails pivotably mounted to the side rails;

FIG. 9 is an elevational perspective view of an article carrier assembly in a deployed position, and includes a pair of side rails and a pair of cross rails pivotably mounted to the side rails;

FIG. 10 is a cross sectional view of the article carrier assembly of FIG. 8, taken along lines 10-10;

FIG. 11 is a cross sectional view of the article carrier assembly of FIG. 9, taken along lines 11-11;

FIG. 12 is a perspective view of a latch plate pivoting mechanism for pivotably mounting a cross rail to a side rail;

FIG. 13 is a cross sectional view of a swell joint pivoting mechanism for pivotably mounting a cross rail to a side rail at a first end of the cross rail;

FIG. 14 is a cross sectional view of a swell joint pivoting mechanism for pivotably mounting a cross rail to a side rail at a second end of the cross rail; and

FIG. 15 is a cross sectional view of a cross rail having a swell joint pivoting mechanism at first and second ends of the cross rail, with the cross rail in a deployed position over two side rails.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

According to various exemplary illustrations described herein, an article carrier assembly is provided that includes at least one side rail and at least one cross rail. The side rail is configured to be installed to a surface of a vehicle, and includes a top surface that defines, at least in part, a maximum height. The cross rail is operable to be secured to the side rail and selectively moveable between a stowed position and a deployed position. The cross rail may be located generally below the maximum height of the side rail when the cross rail is in the stowed position, and in some exemplary approaches above the maximum height of the side rail when the cross rail is in the deployed position. An adjustable mount including a first closure loop for receiving the side rail and a second closure loop for receiving the cross rail may also be provided. When closure loops are used the cross rail may be received by the second closure loop when the cross rail is in the stowed position and may be secured to a top surface of the adjustable mount when in the deployed position.

Further, according to various exemplary illustrations, an article carrier assembly is provided that includes at least one side rail and at least one cross rail, and a pivot mechanism disposed at an end of the cross rail. The side rail includes a top surface that defines, at least in part, a maximum height of the side rail, and the cross rail is operable to be secured to the side rail in a stowed position and a deployed position. The pivot mount secures the cross rail to the side rail, and allows the cross rail to pivot about the end of the cross rail. The cross rail is located generally below the maximum height of the side rail when the cross rail is in the stowed position, and the cross rail is above the maximum height of the side rail when the cross rail is in the deployed position.

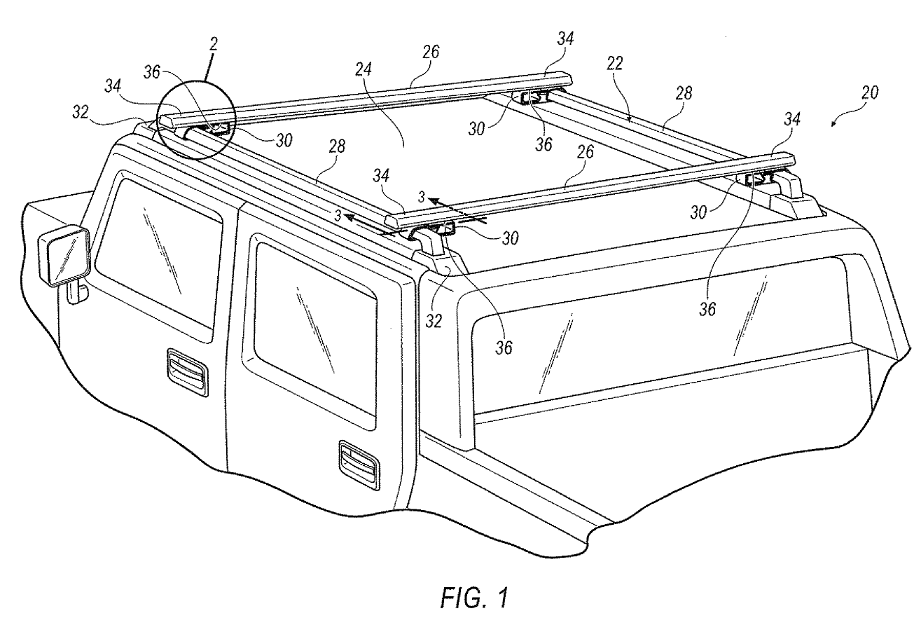

Turning now to the drawings and in particular to FIG. 1, a motor vehicle 20 is illustrated in FIG. 1 having an article carrier assembly 22 secured to a roof 24 of the vehicle 20. The article carrier assembly 22 includes a pair of side rails 28 extending generally from the front to the rear of the vehicle 20, each side rail 28 being disposed between two cross rails 26. The article carrier assembly 22 further includes adjustable mounts 30. In the illustration as shown, four of the adjustable mounts 30 are positioned on side rails 28, where two adjustable mounts 30 are illustrated on each of the ends of the side rails 28. The adjustable mounts 30 are employed to position and secure the cross rails 26 to the side rails 28. Although FIG. 1 illustrates the article carrier assembly 22 located and secured to the roof 24 of the vehicle 20, it should be noted that the article carrier assembly 22 may be located and secured to any substantially planar surface of the vehicle 20, such as, but not limited to, a bed of a pickup truck or a deck lid of a trunk.

The side rails 28 are configured to be installed to a surface of the vehicle 20 in a variety of ways that are known in the art. In one illustrative example, as seen in FIG. 1, the side rails 28 are attached to the roof 24 by a support structure 32. It should be noted that while FIG. 1 illustrates two cross rails 26, only one cross rail 26 or more than two cross rails 26 may be employed as well.

In the illustration as shown in FIG. 1, the article carrier assembly 22 is shown in a deployed position. When in the deployed position, each end portion 34 of the cross rails 26 is shown secured on a top surface 36 of one of the adjustable mounts 30. The adjustable mounts 30 provide stability of the cross rail 26 when stored in either the stowed or deployed position. Accessories or cargo (not shown) can be secured to the article carrier assembly 22 when in the deployed position. When not in use, the article carrier assembly 22 can be placed in a stowed position. More specifically, the cross rail 26 is operable to be secured to the side rail 28 in a stowed position as well as the deployed position, and is discussed in greater detail below.

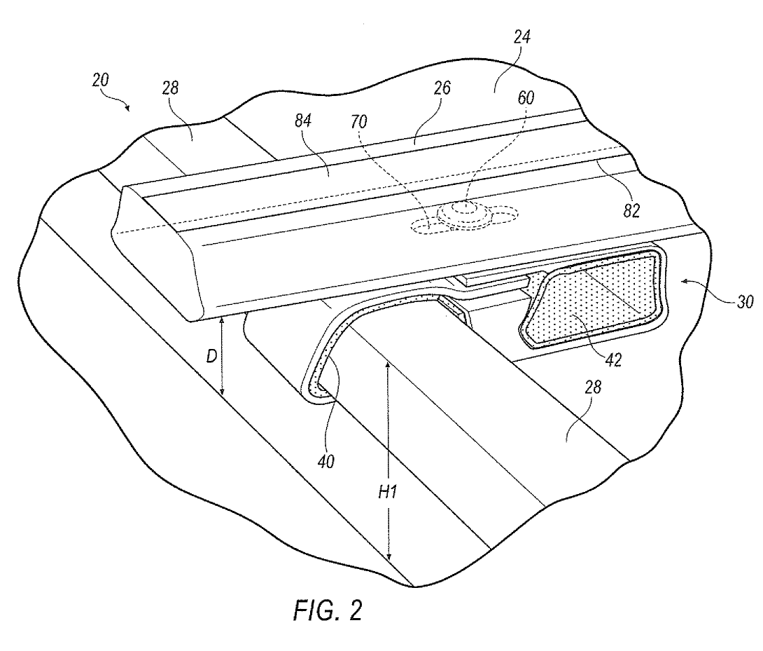

FIG. 2 is an enlarged view of one of the adjustable mounts 30. FIG. 2 illustrates the cross rail 26 in the deployed position. The adjustable mount 30 includes a first closure loop 40 and a second closure loop 42, where the first closure loop 40 receives the side rail 28 and the second closure loop 42 receives the cross rail 26. More specifically, the first closure loop 40 generally conforms and wraps around the side rail 28. The second closure loop 42 similarly conforms around the cross rail 26 when the article carrier assembly 22 is in the stowed position, and is discussed in greater detail below.

When the cross rail 26 is in the deployed position, the cross rail 26 may be above the side rail 28. More specifically, in an exemplary illustration a top surface 38 of the side rail 28 defines a maximum height H1 of the side rail 28. When the cross rail 26 is in the deployed position, the cross rail 26 is shown positioned above the maximum height H1 of the side rail 28 and is also shown generally perpendicular to the side rail 28. Moreover, in the illustration as shown in FIG. 2, the cross rail 26 is secured to the top surface 36 of the adjustable mount 30 when the cross rail 26 is placed in the deployed position. Positioning the cross rail 26 on top the side rail 28 is often desirable to increase the load-carrying capacity of the cross rail 26.

The cross rails 26 are placed generally perpendicular to the side rails 28 in the deployed position and are spaced at a predetermined distance D from the roof 24 of the vehicle 20. Spacing the cross rails 26 at the predetermined distance D will decrease the risk of accessories or cargo contacting the roof 24 of the vehicle 20. It is typically undesirable to have cargo contacting the surface of the roof 24, as such contact may cause damage. For example, if cargo secured to the article carrier assembly 22 contacts the surface of the roof 24, such contact may scratch the surface of the roof 24.

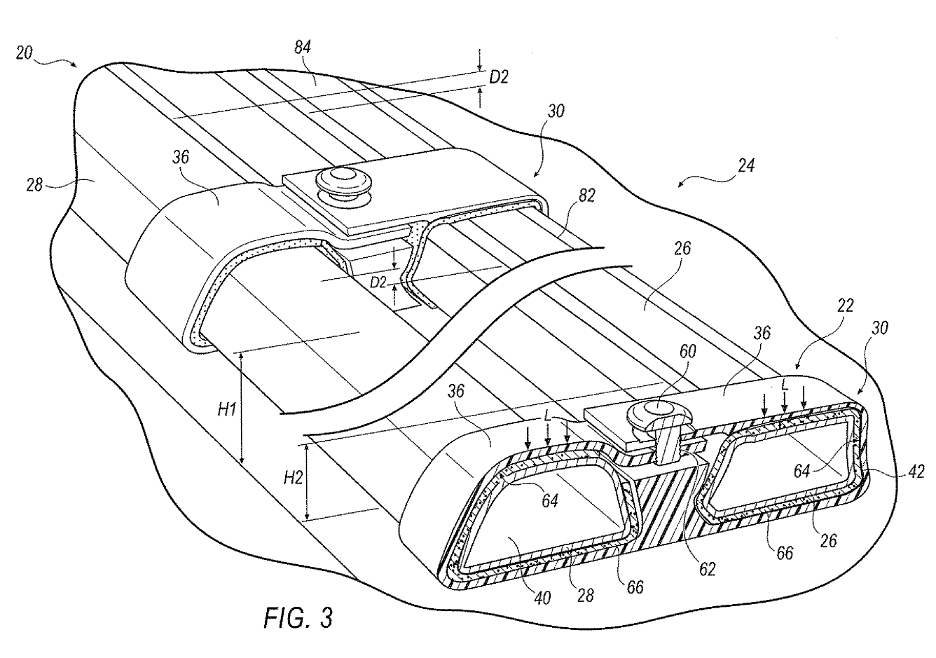

FIG. 3 is a partially sectional side view of the article carrier assembly 22 when in the stowed position. That is, one of the adjustable mounts 30 is shown partially sectioned along line 3-3 of FIG. 1. In the stowed position, the cross rail 26 may be positioned generally parallel to the side rail 28. The cross rail 26 may be positioned generally below the maximum height H1 of the side rail 28 when in the stowed position. That is, as seen in FIG. 3, the side rail 28 includes a height H2 that is generally below the maximum height H1 of the side rail 28. As shown, the difference between H1 and H2 is represented by the distance D2.

Because the cross rail 26 is shown located generally below the maximum height H1 of the side rail 28, the maximum height of the article carrier assembly 22 is defined by the height H1 when in the stowed position. This configuration provides a minimal overall height of the article carrier assembly 22 when the cross rail 26 is in the stowed position, which in turn provides several benefits. For example, the minimal overall height of the article carrier assembly 22 provides less wind noise and increased fuel economy when compared to the article carrier assembly 22 being in the deployed position. Placing the cross rail 26 generally parallel to a longitudinal axis defined between the front and rear of the vehicle 20 also reduces wind noise and increases fuel economy when compared to the deployed position as seen in FIGS. 1-2.

The overall height of the vehicle 20 is reduced when the cross rail 26 is in the stowed position, which may become advantageous when the vehicle 20 is shipped inside of a cargo carrier that has a very limited amount of space. Indeed, when the article carrier assembly 22 is not being utilized to secure accessories or cargo to the roof 24 of the vehicle 20, the article carrier assembly 22 may be placed in the stowed configuration, thus minimizing the overall height of the vehicle.

As seen in FIG. 3, the adjustable mount 30 includes a closure device 60, which in the exemplary illustration is a screw-type fastener. It should be noted that while FIG. 3 illustrates the closure device 60 as a screw-type fastener, any mechanism that secures the first closure loop 40 around the side rail 28 and the second closure loop 42 around the cross rail 26 may be used. For example, the closure device 60 may be a locking pin. Alternatively, the closure device 60 may be omitted, and the first closure loop 40 and the second closure loop 42 may be secured in place by a series of alternative locking mechanism integrated directly into the closure loops such as an integrated hook at a free end received within a corresponding loop or even in some situations potentially fabric hook-and-loop fasteners such as Velcro®.

The grip of the first closure loop 40 around the side rail 28 and the grip of the second closure loop 42 around the cross rail 26 is tightened by the closure device 60. More specifically, the closure device 60 engages both of the first closure loop 40 and the second closure loop 42 by way of a threaded screw hole 62 that receives the illustrated screw-type fastener. In the illustrated example when tightened using a screw mechanism, closure device 60 selectively applies a downward load L that is exerted to both the cross rail 26 as well as the side rail 28. The downward load L further tightens the grip of the first closure loop 40 and the second closure loop 42.

The grip of the first closure loop 40 and the second closure loop 42 may be further enhanced by a pad 66 that lines an inner surface 64 of the first closure loop 40 and the second closure loop 42. The pad 66 is typically constructed from a high-friction material, such as, but not limited to, a foam or a polymer. In one example, the adjustable mount 30 is constructed from a flexible plastic or a rubber.

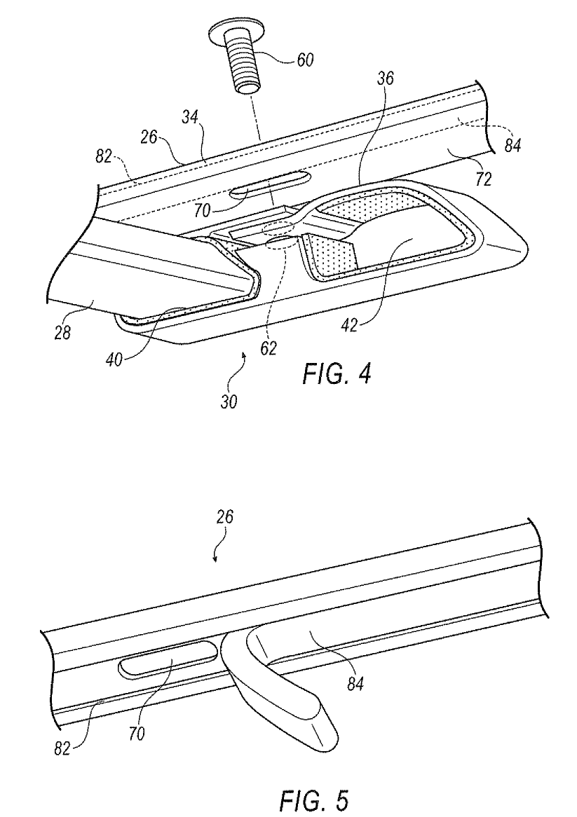

The second closure loop 42 of the adjustable mount 30 may be loosened or opened by loosening or removing the closure device 60. The cross rail 26 may then be removed from the second closure loop 42, and placed on top of the adjustable mount 30, along the top surface 36. More specifically, as best seen in FIG. 4, the cross rail 26 includes an aperture such as a hole or a slot, that is a mounting hole 70 provided along a bottom surface 72 of the cross rail 26.

The closure device 60 may be threaded through the mounting hole 70 and also tightened to the screw hole 62 located in the adjustable mount 30. This secures the cross rail 26 to the adjustable mount 30 when the cross rail 26 is in the deployed position. It should be noted that FIG. 4 is only one exemplary illustration of how the cross rail 26 may be secured to the adjustable mount 30 in the deployed position, and devices other than the closure device 60 and the mounting hole 70 may be used as well. In one example, the cross rail 26 may include a feature, such as an outwardly extending tab, located along the bottom surface 72 that is received and in engagement with the hole 62 of the adjustable mount 30. It should also be noted that while FIG. 4 illustrates the closure device 60 being utilized for both the stowed and the deployed positions, separate securing mechanisms can be used for each of the stowed and the deployed positions as well.

When a user desires to move the cross rail 26 from the deployed position as seen in FIGS. 1-2 to the stowed position as seen in FIG. 3, a user will first loosen and potentially remove the closure device 60 from the screw hole 62 of the adjustable mount 30 and from the mounting hole 70 of the cross rail 26. The closure device 60 is accessed though a removable insert 84 that covers an attachment slot 82 of the cross rail 26, and is explained in greater detail below. Removing the closure device 60 from the cross rail 26 and the adjustable mount 30 will allow for the cross rail 26 to be removed from the top surface 36 of the adjustable mount 30. Once the cross rail 26 is removed, a user may then place the cross rail 26 within the second closure loop 42 of the adjustable mount 30, as seen in FIG. 3. Once positioned within the second closure loop 42, the cross rail 26 is now in the stowed position.

A user may also remove the cross rail 26 from the second closure loop 42 when the cross rail 26 is in the stowed position and place the cross rail 26 in the deployed position as well. As discussed above, the second closure loop 42 of the adjustable mount 30 may be loosened or opened by loosening or removing the closure device 60. The cross rail 26 is then removed from the second closure loop 42, and secured to the top surface 36 of the adjustable mount 30 in the deployed position.

In some situations when the article carrier assembly 22 is not in use, a user may desire to completely remove the cross rail 26 from the article carrier assembly 22. A user may also remove the adjustable mount 30 from the side rail 28 as well. Removing the cross rail 26 and the adjustable mount 30 from the article carrier assembly 22 is advantageous, because the absence of the cross rail 26 and the adjustable mount 30 will result in reduced wind noise, increased fuel economy, and a decrease in overall vehicle height when the article carrier assembly 22 is not in use, as discussed above.

The cross rail 26 may include at least one feature which facilitates the attachment of accessories or cargo. FIG. 5 illustrates the cross rail 26 with the accessory attachment slot 82 that extends along the cross rail 28. The attachment slot 82 may extend along the entire length of the cross rail 26, or the attachment slot 82 may only extend along a portion of the rail as well.

The accessory attachment slot 82 allows for accessories to be secured to the cross rail 26 by positive engagement with the attachment slot 82. The cross rail 26 may also includes the insert 84 that covers the attachment slot 82 when not in use. In one illustration, the insert is constructed from a flexible material, such as rubber. It should be noted that while FIG. 5 illustrates the attachment slot 82, other features, such as, but not limited to, holes, slots or tabs may also be provided along the cross rail for securing accessories as well.

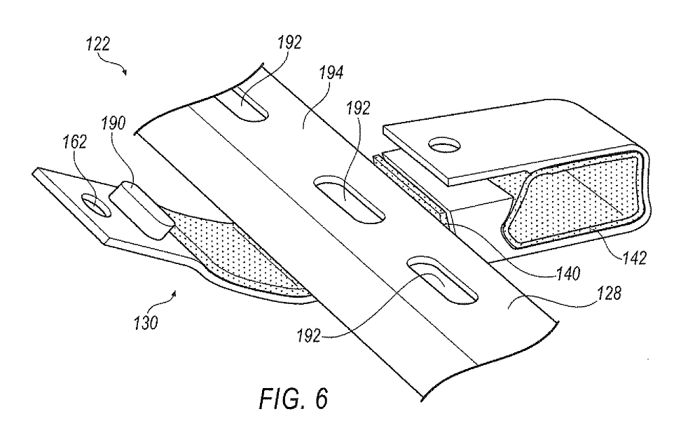

In one alternative illustration, the side rail 128 can be secured to the adjustable mount 30 at several defined positions along the side rail 128. For example, in the alternative illustration of FIG. 6, the adjustable mount 130 includes a tab 190 that is in engagement with one of the mounting holes 192 that are located along an upper surface 194 of the side rail 128. The mounting holes 192 are positioned at predetermined locations along the upper surface 194 of the side rail 128.

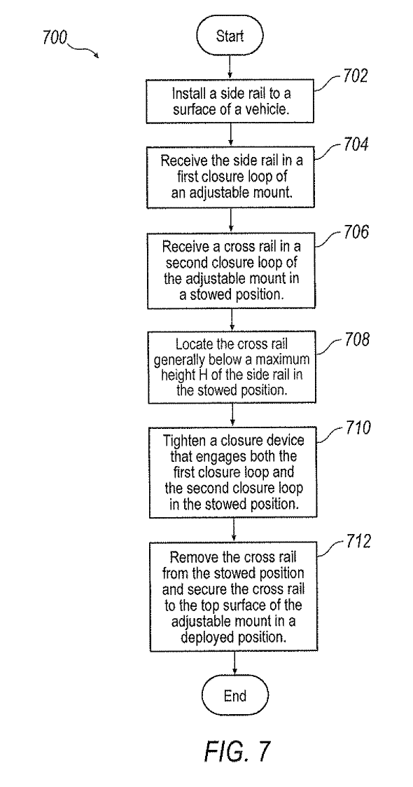

Turning now to FIG. 7, a process 700 for deploying and stowing the cross rail of the article carrier assembly is illustrated. Process 700 may begin at step 702, where a side rail 28 is installed to a surface of a vehicle. For example, as discussed above, the side rail 28 is installed to the vehicle 20 at the roof 24. The side rail 28 includes the top surface 36 that defines, at least in part, a maximum height H1. However, in some alternative approaches step 702 is omitted in its entirety of carried out at a later time. For example, it is possible for side rail 28 and cross rail 26 to be shipped as an assembly in a stowed position without mounting the side rail to a vehicle. The cross rail 26 would not impede the ability to carry out step 702 at a later time such as at an assembly plant when the stowed assembly is then mounted by way of side rail 28 as discussed with respect to step 702. An advantage of such an approach is that there are fewer parts to manipulate as part of the assembly process and the cross rails 26 do not impede assembly. Typically, when installing a side rail 28, fasteners extend through an opening in the side rail and into a corresponding vehicle component. Process 700 may then proceed to step 704.

In step 704, the side rail is received in a first closure loop of an adjustable mount. For example, as discussed above, the first closure loop 40 of the adjustable mount 30 receives the side rail 28. More specifically, the first closure loop 40 generally conforms and wraps around the side rail 28. Process 704 may then proceed to step 706.

In step 706, a cross rail is received in a second closure loop of the adjustable mount when the cross rail is in a stowed position. For example, as discussed above, the second closure loop 42 receives the cross rail 26. Process 706 may then proceed to step 708.

In step 708, the cross rail is located generally below the maximum height of the side rail in the stowed position. For example, as discussed above, the cross rail 26 is located generally below the maximum height H1 of the side rail 28. Process 708 may then proceed to step 710.

In step 710, a closure device that engages both of the first closure loop and the second closure loop is tightened. For example, as discussed above, the closure device 60 applies the downward load L that further tightens the grip of the first closure loop 40 and the second closure loop 42. Process 708 may then proceed to step 710.

In step 712, the cross rail is removed from the stowed position and placed in the deployed position by securing the cross rail to the top surface of the adjustable mount by an aperture in the cross rail. For example, as discussed above, a user may remove the cross rail 26 from the second closure loop 42 when the cross rail 26 is in the stowed position. The second closure loop 42 of the adjustable mount 30 may be loosened or opened by loosening or removing the closure device 60. The cross rail 26 is then removed from the second closure loop 42. The cross rail 26 includes an aperture such as the mounting hole 70 provided along the bottom surface 72 of the cross rail 26. The closure device 60 may be threaded through the mounting hole 70 and also tightened to the screw hole 62 located in the adjustable mount 30. This secures the cross rail 26 to the adjustable mount 30 when the cross rail 26 is in the deployed position. Process 700 may then terminate.

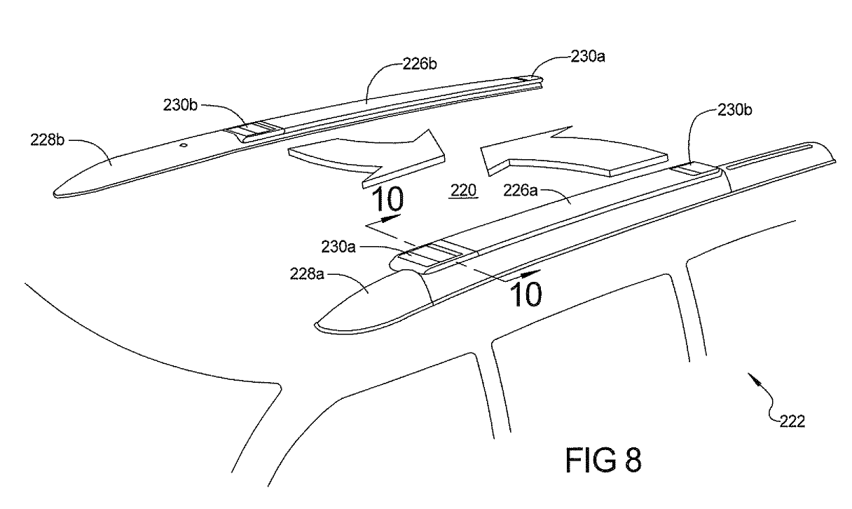

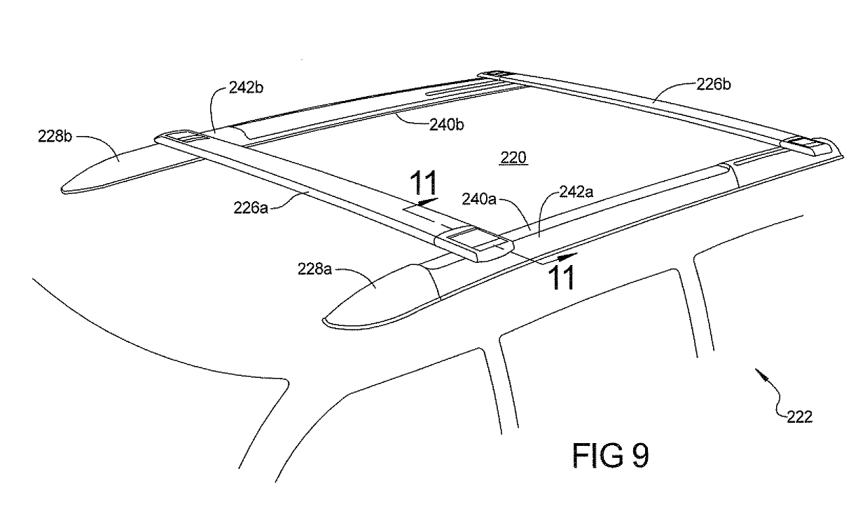

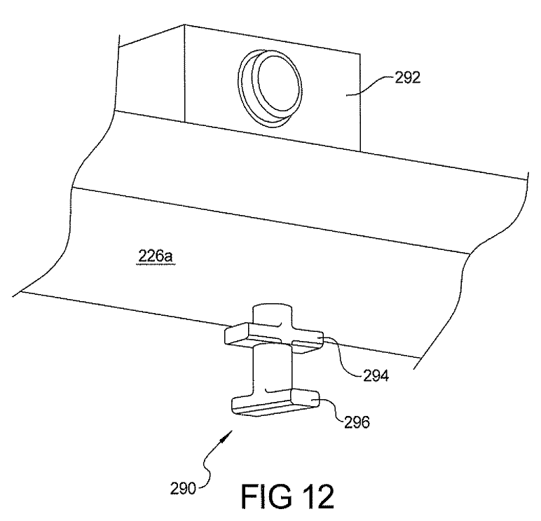

Turning now to FIGS. 8-15, an example of an article carrier assembly 222 having pivotable cross rails 226a, 226b (collectively, 226) is illustrated. Article carrier assembly 222 generally includes a pair of generally longitudinally extending side rails 228a, 228b that are selectively secured to an outer surface of a vehicle 220, and at least one cross rail 226 which attaches to at least one side rail 228 with a pivoting mount 230a, 230b (collectively, 230) disposed at each end of the cross rail 226. Each side rail 228 may be secured to a top surface of a vehicle 220 in any manner known in the art. Merely as examples, the side rail may be attached to a support structure which is in turn secured to a top surface of a vehicle 220, or may be secured directly to a surface of vehicle 220, as shown in FIGS. 8 and 9. Virtually any side rail may be employed that allows for attachment to a surface of a vehicle.

The cross rails 226 may comprise any generally straight rail structure, for example as described above for cross rails 26. More specifically, the cross rails 226 may include at least one feature which allows for attachment of accessories or cargo. For example, the cross rails may include an accessory attachment slot (not shown in FIGS. 8 and 9) along a portion of the cross rail 226, and an insert, e.g., formed of a flexible material, to cover the accessory attachment slot, such as described above in regard to cross rails 26. Further, other features may be provided on the cross rail in place of or in addition to the attachment slot, such as holes, slots, or tabs anywhere along the cross rail for securing accessories or cargo, such as with rope or flexible bungee cords. While the cross rails 226 may generally be relatively stiff to provide adequate load-carrying ability, the cross rails may also at the same time be somewhat flexible to prevent interference between each cross rail 226a, 226b that would otherwise prevent the cross rails 226a, 226b from being pivoted to a deployed position. In other words, one or both cross rails 226 may be sufficiently flexible that they may pass over or under the other cross rail 226 when both cross rails 226 are being pivoted from a stowed position to a deployed position.

The cross rails 226 may have two pivoting mounts 230a, 230b (collectively, 230) that are disposed at each end of the cross rail 226. A first pivot mount 230a may generally allow for a first end of cross rail 226a to be secured to the side rail 228a, while also allowing the cross rail 226a to pivot about the pivot mount 230a. A second pivot mount 230b may generally allow the opposite end of cross rail 226a to be selectively secured to side rail 228a when cross rail 226a is in a stowed position, wherein the cross rail 226a is generally parallel to side rail 228a, and to side rail 228b when cross rail 226a is in a deployed position, wherein the cross rail 226a is generally perpendicular to side rail 228a. Further, each pivot mount 230 may be generally identical, such that each pivot mount 230a, 230b is capable of allowing selective pivoting about an associated end of a cross rail 226 and selective securement of the associated end of the cross rail 226 to a side rail 228. Accordingly, while the operation of the pivot mount 230a is substantially described below in conjunction with cross rail 226a, the concepts described herein are generally applicable to pivot mount 230b, and also to cross rail 226b and its respective pivot mounts 230a, 230b.

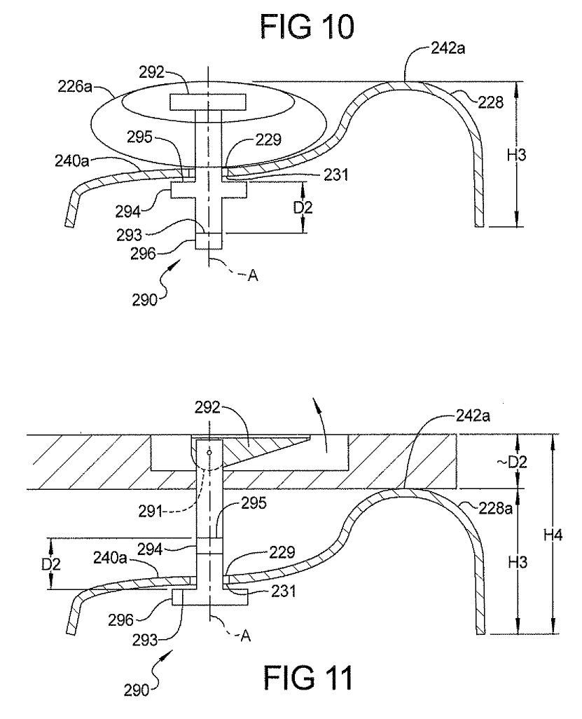

As briefly described above, the pivoting mounts 230 generally allow the cross rails 226 to be placed in a stowed position, wherein each cross rail 226 is secured to the side rail 228, generally parallel to the side rail 228, as best seen in FIGS. 8 and 10. Further, as best seen in FIG. 10, the cross rails 226a may each generally reside on top of a lower surface 240a of side rail 228a, such that the cross rail 226a does not extend beyond a maximum height of the side rail 228a defined at least in part by an upper surface 242a of the side rail 228a. Accordingly, the article carrier 222 allows the cross-rails 226 to be stowed generally parallel to the side rails 228 at a first height which generally minimizes overall height of the article carrier 222, resulting in a correspondingly minimal overall height of the vehicle 220, thereby reducing fuel consumption and wind noise.

As best seen in FIG. 9, the pivoting mount 230a also allows the cross rail 226a to be pivoted about one end of the cross rail 226a, e.g., as shown in FIG. 8, a generally forward end of the cross rail 226a, from the stowed position to a deployed position. A pivoting mount 230a located at a first end of the cross rail 226a may generally allow cross rail 226a to pivot about the mount 230a. A second pivoting mount 230b disposed at an opposite end of the cross rail 226a may allow selective engagement and disengagement of that end of the cross rail 226a with side rails 228a and 228b. When the cross rail 226 is placed in the deployed position, one end of cross rail 226a may sit upon or be secured to a raised surface 242a of one of the side rails 228a, and the other end sits upon or is secured to a raised surface 242b of the other side rail 228b. The pivoting mount 230a thus allows cross rail 226a to be lifted generally upward from the stowed position, where the cross rail 226a is below the height H3 of the side rails 228a, to the deployed position, where the cross rail 226a generally sits upon raised surfaces 242a of the side rails 228, and thus is at least partially or even entirely disposed above the maximum height H3 of the side rails 228. In other words, the article carrier 222 allows the cross-rails 226 to be deployed in a position generally higher, or spaced further away from a surface of the vehicle 220, than the cross rail 226 in the stowed position. The deployed position of the cross-rails 226 thus spaces the cross rails 226 further away from the vehicle 220, generally allowing for greater load-carrying ability and ease of use of the article carrier 222.

The pivoting mount 230 generally allows each cross-rail 226 to be pivoted between the stowed and deployed positions while maintaining a connection between the cross-rail 226 and a side rail 228 at one end of the cross rail 226, such that the cross-rail 226 does not need to be completely removed from the side rail 228 while switching the cross-rail from the stowed position to the deployed position, and vice versa. Any types of pivoting mounts 230, e.g., a post, swivel, etc., may be provided for the cross-rails 226 and/or side rails 228 to allow for securing the cross-rails 226 in the stowed and deployed positions, and pivoting cross rails 226 between the stowed and deployed positions.

With particular attention to FIGS. 10-12, an example of a pivot mount 230 is explained in further detail. A pivot mount 230 may generally include a bolt 290 that is actuated by a cam handle 292. Cam handle 292 may be pivotally secured to bolt 290, thereby allowing a cam surface 291 of cam handle 292 to raise and lower bolt 290 according to the rotation of the cam handle 292 by generally pushing off of an upper surface of the cross rail 226a. For example, as best seen in FIG. 11, clockwise rotation of cam handle 292 generally brings bolt 290 upwards as cam surface 291 spaces the cam handle 292 further away from the cross rail 226a, thereby tightening bolt 290 against an interior surface 229 of side rail 228a, as will be describe further below. Similarly, counter-clockwise rotation of cam handle 292 moves bolt 290 downward, thereby loosening bolt 290 against the interior surface 229 of side rail 228a. Further, cam handle 292 rotates or spins bolt 290 about its axis A, allowing selective engagement and disengagement of bolt 290 with interior surface 229 of side rail 228a, and in particular of latch plates 294, 296 with interior surface 229, as will be described further below.

Bolt 290 includes a lower latch plate 296 provided at or adjacent an end of the bolt 290, and an upper latch plate 294 that is oriented 90 degrees relative to the lower latch plate 296. Each latch plate 294, 296 may have an engagement surface 295, 293, respectively, for abutting and/or clamping against an interior surface 298 of side rail 228a according to the movement of bolt 290 by cam handle 292. Further, cam handle 292 may rotate bolt 290, and each of latch plates 294, 296, about an axis A of bolt 290, allowing each latch plate 294, 296 to be selectively moved between a slot 231 of the side rail 228a. Accordingly, cam handle 292 may (1) turn bolt 290 about axis A to allow the latch plates 294, 296 to be aligned with the slot 231, (2) translate bolt 290 up and down to move each latch plate 294, 296 through the slot 231, and (3) selectively clamp each engagement surface 293, 295 against interior surface 229 of side rail 228a.

As best seen in FIG. 11, each of the engagement surfaces 293, 295 are spaced a predetermined distance D2 apart. Distance D2 may generally correspond to a difference in height between the cross rail 226a when it is in the stowed position, i.e., H3, and when it is in the deployed position, i.e., H4. In other words, the distance D2 may generally correspond to a vertical distance that bolt 290 is raised when moving cross rail 226a from the stowed position to the deployed position. The engagement surface 295 of upper latch plate 294 may abut, engage, or clamp against interior surface 229 of side rail 228a when the cross-rail 226a is in a stowed position, as best seen in FIG. 10. Further, the engagement surface 293 of lower latch plate 296 may engage the interior surface 229 when the cross-rail 226 is in the deployed position. Accordingly, the predetermined distance D2 between the engagement surfaces 293, 295 generally allows the bolt 290 to engage the interior surface 229 of the side rail 228 in each respective position, and also allows the cross rail 226a to be selective moved vertically between the stowed and deployed positions.

Accordingly, cam handle 292 may thus manipulate bolt 290 to allow, in turn, clamping and unclamping of the engagement surface 295 against interior surface 229 when the cross rail 226a is in the stowed position (as best seen in FIG. 10), pivoting of cross rail 226a about bolt 290 when the cross rail 226a is moved from the stowed to the deployed position, and clamping and unclamping of engagement surface 293 against interior surface 229 when the cross rail 226 is in the deployed position (as best seen in FIG. 11). More specifically, beginning with FIG. 10, cam handle 292 may clamp engagement surface 295 of upper latch plate 294 against interior surface 229 when cross rail 226a is in the stowed position, thereby securely retaining the associated end of the cross rail 226a against the side rail 228. Cam handle 292 may then be rotated to move bolt 290 slightly downward and/or out of abutting engagement with interior surface 229. Cam handle 292 may then be turned ninety degrees about axis A, thereby also rotating bolt 290 about the axis A such that upper latch plate 294 is aligned generally parallel with the longitudinal slot 231 defined in lower surface 240a of side rail 228a. Cam handle 292 may then be pulled generally upwards, sliding bolt 290 upwards and moving upper latch plate 294 through the slot 231. Bolt 290 is thus raised upwards, such that cross rail 226a may be similarly lifted upwards. Cross rail 226a may then be rotated about bolt 290, such that it rests upon upper surface 242a of side rail 228a, as best seen in FIG. 11. Cam handle 292 may then be rotated about axis A ninety degrees, positioning the engagement surface 293 of lower latch plate 296 for engagement with interior surface 229. Cam handle 292 may then be rotated clockwise, as shown in FIG. 11, so that bolt 290 is urged upwards, bringing engagement surface 293 of lower latch plate 296 into clamping engagement with interior surface 229 of side rail 228a. Pivot mechanism 230 thus may generally secure cross rail 226a in the deployed position.

The pivot mechanism 230b of cross rail 226a may allow selective disengagement with the side rails 228, to allow the associated end of the cross rail 226a to be moved between each respective side rail 228a, 228b while the cross rail 226a is pivoted about pivot mount 230a. For example, a cam handle 292 of pivot mount 230b may rotate bolt 290 to align lower latch plate 296 generally parallel with the longitudinal slot 231 of side rail 228a, allowing the lower latch plate 296 to be moved through the slot and the bolt 290 to be fully removed from the side rail 228a, and freeing the end of cross rail 226a adjacent pivot mount 230b for disengagement from side rail 228a, pivoting of cross rail 226a about pivot mount 230a, and engagement with side rail 228b.

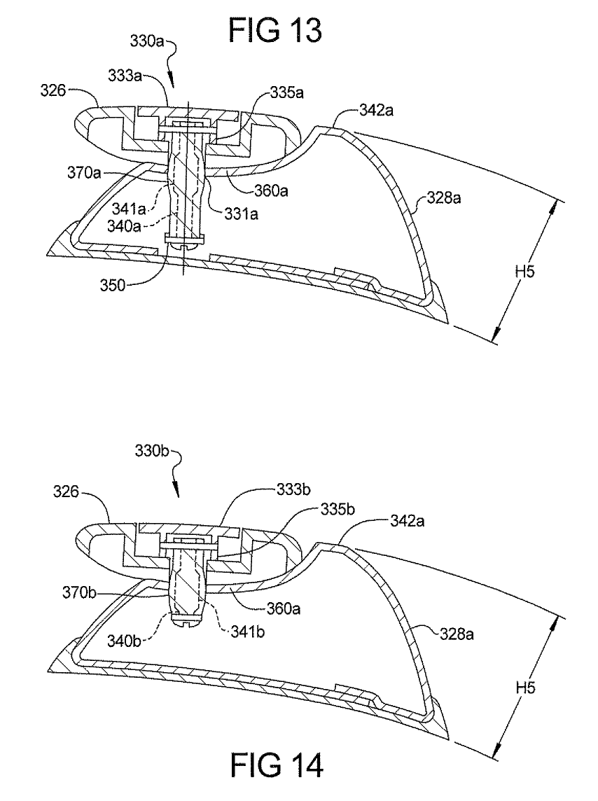

Turning now to FIGS. 13-15, another example of a pivot mount is illustrated. A swell joint 330a, 330b (collectively, 330) may be provided at each end of a cross-rail 326. With particular attention to FIG. 13, which illustrates a first end of the cross-rail 326, swell joint 330a may include a long bolt 340a having an intermediate bushing 370a. The intermediate bushing 370a may be formed of any generally flexible material, e.g., rubber. The intermediate bushing 370a is generally sized to fit through an orifice 331 provided in the side rail 328, to allow the cross-rail 326 to pivot about the long bolt 340a. The intermediate bushing 370a may be expanded by a vertical movement of the bolt 340a. An actuating handle 333a having a cam surface 335a secured at or near the top of the bolt 340a may selective move bolt 340a up and down, thereby initiating selective expansion and contraction of the intermediate bushing 370a. Expansion of the intermediate bushing 370a, such as may be caused by a bulge 341a or other feature of bolt 340a, causes the intermediate bushing 370a to engage the orifice 331 in the side rail 328, generally securing the end of the cross-rail 326 to the side rail 328a. Contraction of the intermediate bushing 370a similarly causes the intermediate bushing 370a to disengage the orifice 331 and allow vertical movement of long bolt 340a within the orifice 331.

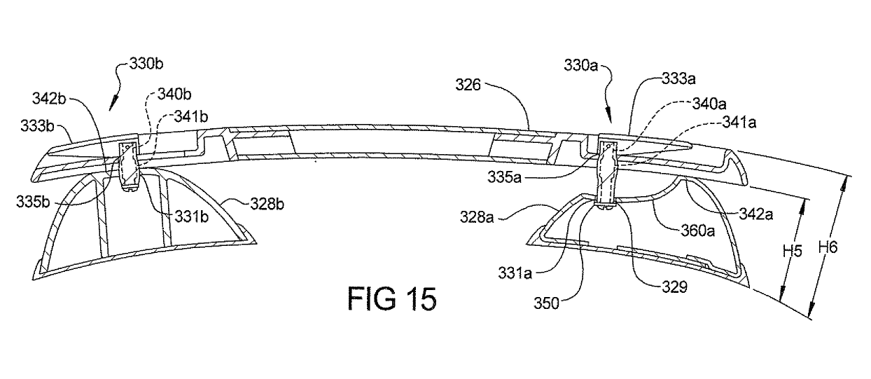

Turning now to FIG. 15, a lock plate 350 may be formed at an end of the long bolt 340a to engage an interior surface 329 of the side rail 328a when the cross-rail 326 is pivoted to the deployed position, such that the cross-rail 326 is secured to the side rail 328a by the lock plate 350. For example, the actuating handle 333a may selectively move the lock plate 350 up and down to engage and disengage the lock plate 350 with the interior surface 329. The lock plate 350 generally prevents upward movement of the cross-rail 326 when engaged with interior surface 329, while abutment between a bottom surface of the cross-rail 326 and a top surface 342 of the side rail 328 generally prevents downward movement of the cross-rail 326. The length of the long bolt 340a generally allows the cross-rail 326 to sit a predetermined distance H6 above surface to which the side rail 328 is attached, in comparison with a maximum height of the side rails 328, represented by height H5.

As shown in FIG. 14, a swell joint 330b may also be provided at a second end of a cross-rail 326, opposite the end at which swell joint 330a is provided. The swell joint 330b at this end may have a short bolt 340b with a length shorter than the long bolt 340a, as the short bolt 340b engages an orifice 331b in an upper surface 342b of the opposite side rail 328b when the cross rail 326 is in the deployed position. In other words, a height of the orifice 33 lb in the opposite side rail 328b generally corresponds to the upper surface 342a in the first side rail 328a, upon which the cross-rail 326 is disposed in the deployed position. The swell joint 330b may include an intermediate bushing 370b actuated by an actuating handle 333b, where the actuating handle 333b includes a cam surface 335b, similar to intermediate bushing 370a. Further, intermediate bushing 370b may be urged into and out of engagement with orifice 331b of side rail 328b, thereby selectively engaging and disengaging the cross rail 326 with the opposite side rail 328b.

The article carrier 222 therefore has at least one cross rail 226 which may be placed in a lowered or stowed position where the cross rail 226 is parallel to a first side rail 228a to which it is secured. The cross-rail 226 generally sits at a first height in the stowed position, which may be generally below, or at least not substantially above, a maximum height of the first side rail 228a, thereby generally minimizing an overall height of the article carrier 222 to provide reduced wind noise, fuel consumption of the vehicle, and overall height of the vehicle. When a user desires to load accessories or cargo to the article carrier, the pivot mounts 230 or 330 may be unlocked at each end of the cross-rail 226. The cross-rail 226 may then be pivoted about the one end to engage a second side rail 228b opposite the first side rail 228a. In embodiments employing a bolt 290 having two offset latch plates 294, 296, a lower latch plate 296 may remain engaged with the side rail 228a at a first end of the cross rail 226a, while a lower latch plate 296 is completely freed from the side rail 228a at the opposite end of the cross rail 226a, thereby allowing the opposite end of the cross rail 226a to be removed from the side rail 228a and secured to the opposite side rail 228b. In embodiments employing a swell joint 330, a long bolt 340a provided in a first secured end of the cross-rail 326 allows the secured end to be lifted generally vertically to sit atop a raised surface 342a of the first side rail 328a while maintaining a connection to the first side rail 328a, such that the cross-rail 326 is positioned at a second height generally above the first height. Accordingly, articles or objects secured to the cross-rail are spaced further away from the vehicle, generally allowing greater load carrying capacity and reduced risk of damage to the vehicle surface from accessories and/or cargo which is secured to the cross rail. The article carrier therefore provides both a lower overall article carrier height during non-use, as well as an elevated cross rail in the deployed position which generally allows for greater load capacity than if the cross rail were positioned adjacent or below the side rail. Further, the various examples provided herein of a pivot mechanism 230 or 330 generally allow the cross-rail to pivot about one end of the cross-rail, eliminating any need to completely remove or disassemble the article carrier. This may eliminate damage to the cross-rail that may occur as a result of completely separating the cross-rail from the side rail.

While the present disclosure has been particularly shown and described with reference to the foregoing preferred illustrations, it should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure illustrations within the scope of these claims and their equivalents be covered thereby. This description of the disclosure should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application.

What is claimed is:

1 An article carrier assembly for a vehicle, comprising:
a side rail including a top surface that defines, at least in part, a maximum height of the side rail; and
at least one cross rail operable to be secured to the side rail in a stowed position and a deployed position; and
a pivot mount disposed at an end of said at least one cross rail, said pivot mount operable to secure said at least one cross rail to said side rail, and allow said at least one cross rail to pivot about said end of said at least one cross rail;
wherein the cross rail is located generally below the maximum height of the side rail when the cross rail is in the stowed position, and the cross rail is above the maximum height of the side rail when the cross rail is in the deployed position.

2. The article carrier assembly as recited in claim 0, wherein the pivot mount includes a bolt selectively engaging an interior surface of said side rail.

3. The article carrier assembly as recited in claim 2, wherein said bolt includes upper and lower latch plates.

4. The article carrier assembly as recited in claim 3, wherein a spacing between said upper and lower latch plates corresponds to a difference in height between the cross rail when it is in the stowed position and the cross rail when it is in the deployed position.

5. The article carrier assembly as recited in claim 2, wherein the pivot mount includes a cam handle configured to rotate said bolt about an axis of the bolt, the cam handle further configured to selectively clamp said upper and lower latch plates of the bolt against an interior surface of said side rail.

6. The article carrier assembly as recited in claim 2, wherein the pivot mount includes a cam handle configured to rotate said bolt about an axis of the bolt to selectively align said upper and lower latch plates with a slot defined by said side rail.

7. The article carrier assembly as recited in claim 1, wherein the cross rail is in the deployed position when the cross rail is secured to a top surface of the adjustable mount.

8. The article carrier assembly as recited in claim 1, wherein the cross rail is in the stowed position when the cross rail is positioned generally parallel with the side rail.

9. The article carrier assembly as recited in claim 1, wherein the cross rail is in the deployed position when the cross rail is positioned generally perpendicular to the side rail.

10. The article carrier assembly as recited in claim 1, further comprising a second pivot mount disposed at a second end of said at least one cross rail, said second pivot mount configured to selectively secure said second end of said at least one cross rail to said side rail.

11. The article carrier assembly as recited in claim 10, further comprising a second side rail, wherein said second pivot mount is configured to selectively secure said second end of said at least one cross rail to said second side rail.

12. A article carrier assembly for a vehicle, comprising:
a side rail including a top surface that defines, at least in part, a maximum height;
at least one cross rail operable to be secured to the side rail in a stowed position and a deployed position; and
first and second pivot mounts disposed at opposite ends of said at least one cross rail, said pivot mounts operable to secure said at least one cross rail to said side rail, and allow said at least one cross rail to pivot about a first end of said at least one cross rail;
wherein said cross rail is located generally below the maximum height of the side rail when the cross rail is in the stowed position; and
wherein the cross rail is above the maximum height of the side rail when the cross rail is in the deployed position.

13. The article carrier assembly as recited in claim 12, wherein the pivot mount includes a bolt selectively engaging a slot of said side rail.

14. The article carrier assembly as recited in claim 13, wherein said bolt includes upper and lower latch plates.

15. The article carrier assembly as recited in claim 14, wherein a spacing between said upper and lower latch plates corresponds to a difference in height between the cross rail when it is in the stowed position and the cross rail when it is in the deployed position.

16. The article carrier assembly as recited in claim 13, wherein the pivot mount includes a cam handle configured to rotate said bolt about its axis, the cam handle further configured to selectively clamp upper and lower latch plates of the bolt against an interior surface of said side rail.

17. The article carrier assembly as recited in claim 13, wherein the pivot mount includes a cam handle configured to rotate said bolt about an axis of the bolt to selectively align said upper and lower latch plates with a slot defined by said side rail.

18. The article carrier assembly as recited in claim 12, wherein the cross rail includes an accessory attachment slot extending along at least a portion of the cross rail.

19. The article carrier assembly as recited in claim 12, wherein the cross rail is in the deployed position when the cross rail is positioned generally perpendicular to the side rail.

20. The article carrier assembly as recited in claim 12, wherein the cross rail is in the stowed position when the cross rail is positioned generally parallel with the side rail.
